(19) United States
(12) Patent Application Publication
(10) Pub. No.: US 2026/0348340 A1
(43) Pub. Date: Nov. 5, 2026

(54) THRUST REVERSER COMPRISING AT LEAST ONE DEPLOYABLE DEFLECTING MEMBRANE

(71) Applicant: SAFRAN NACELLES, Gonfreville-L'orcher (FR)

(72) Inventors: Patrick GONIDEC, Moissy-Cramayel (FR); Julien CHANDELIER, Moissy-Cramayel (FR); Patrick André BOILEAU, Moissy-Cramayel (FR); François CONTE, Moissy-Cramayel (FR); Loïc Hervé André LE BOULICAUT, Moissy-Cramayel (FR); Philippe WIERTEL, Moissy-Cramayel (FR); Alexandre GORZKO, Moissy-Cramayel (FR); Vincent GARS, Moissy-Cramayel (FR)

(73) Assignee: SAFRAN NACELLES, Gonfreville-L'orcher (FR)

(21) Appl. No.: 19/485,145

(22) PCT Filed: May 17, 2024
(86) PCT No.: PCT/FR2024/050645

§ 371 Date: Nov. 17, 2025

(30) Foreign Application Priority Data
May 23, 2023 (FR) FR2305100

(51) Int. Cl. F02K 1/72; B64D 29/00

(52) U.S. Cl. CPC F02K 1/72; B64D 29/00

(57) ABSTRACT

A thrust reverser for an aircraft propulsion assembly, including a deployable deflecting or obstructing membrane designed to deflect or obstruct at least a portion of the secondary flow escaping from a radial extraction opening when this membrane is in a deployed configuration adopted when the movable structure of the reverser is in a retreated thrust reversal position. According to the invention, in this deployed configuration, the membrane has a generally radially outwardly curved shape defining, at a base of the membrane, an air inlet opening via which air can enter the membrane, the membrane extending between a membrane front portion forming a forward flap reaching to the base of the membrane; and a membrane rear portion forming a rearward flap reaching to the base of the membrane.

### TECHNICAL FIELD

The invention relates to the field of nacelles and thrust reversers for an aircraft propulsion assembly, and, more particularly, to thrust reversers equipped with deployable membranes.

### PRIOR ART

Thrust reversers are devices making it possible to deflect the air flow through the propulsion assembly toward the front, so as to shorten landing distances and limit the load on the brakes on the landers.

Cascade reversers currently used in the aeronautical sector comprise deflecting cascades integrated into a fixed or movable structure of the reverser. The movable structure of the reverser comprises one or more movable reverser cowls, and it is mounted translatable relative to the fixed structure between an extended direct thrust position, and a retreated thrust reversal position.

In the retreated thrust reversal position, to deflect at least a portion of the secondary flow toward the cascades, the reverser is usually equipped with sealing flaps, which, when they are deployed, seal the secondary flow path at least partially. In a known manner, this forces the air from the secondary flow radially outward, toward the cascades, which then generate the counter-thrust air flow toward the front.

The flaps are generally pivotably mounted on the radially inner wall of the movable reverser cowls, this wall delimiting the secondary flow path radially outward. Thus, recesses are provided in this radially inner wall of the reverser cowls in order to receive the sealing flaps in the retreated position, as adopted in direct jet. Nevertheless, in direct jet, the presence of the recesses and flaps is a source of aerodynamic disturbances on the secondary flow. In addition, this presence locally limits the installation of an acoustic panel on the radially inner wall of the reverser cowls.

To provide a technical solution to these problems, it has been proposed to replace the flaps with one or more deployable membranes for sealing the secondary flow path. Such a design is, for example, known from document FR 3 076 864 A1.

While the presence of deployable sealing membranes in the secondary flow path makes it possible to limit the overall mass of the reverser, it remains impacted by the presence of the deflecting cascades. These cascades incorporate fins/vanes intended to rectify the flow to the front to obtain the counter-thrust function. The radial height of these deflecting fins being limited by the need to house the deflecting cascades inside the reverser in direct jet configuration, it is sometimes necessary to increase the axial length of these cascades, in order to obtain the sufficient number of fins necessary to obtain the required counter-thrust performance.

This increase in the length of the deflecting cascades generates an increase in the length of several reverser components, such as the movable reverser cowl(s), actuators, etc. This inevitably results in a more substantial reverser mass and also a greater drag, synonymous with a specific consumption increase.

To address this problem, it has been proposed to replace all or part of the cascades by one or more deployable deflecting membranes, designed to deflect at least a portion of the secondary flow escaping from the radial extraction opening, when this deflecting membrane is in a deployed configuration adopted when the movable structure is in the retreated thrust reversal position. However, the solutions provided prove to have ample scope for improvement when, for example, an outlet air flow with a non-zero, even substantial, tangential component, or even an air flow with a zero axial component, which does not contribute to counter-thrust, is sought locally.

Indeed, if the forward axial component of the air flows exiting the deflecting membranes is used to obtain the sought counter-thrust, an optional tangential component may be applied in order to limit air projections toward the aircraft fuselage, and/or in order to avoid air reinjection phenomena within the turbomachine or that adjacent to it.

### Disclosure of the invention

To at least partially solve the drawbacks mentioned above, relating to embodiments of the prior art, the invention firstly relates to a thrust reverser for an aircraft propulsion assembly, the reverser comprising a fixed structure equipped with a radially inner wall for delimiting a secondary flow path of the propulsion assembly intended to be crossed by a secondary flow, the reverser also comprising a movable structure comprising at least one movable reverser cowl equipped with a radially inner reverser cowl wall delimiting the secondary flow path radially outward, the movable structure being translatable relative to the fixed structure along a longitudinal central axis of the reverser, between an extended direct thrust position, and a retreated thrust reversal position wherein the movable structure and the fixed structure axially define between them, on the secondary flow path, a radial extraction opening of at least a portion of the secondary flow, the thrust reverser also comprising at least one deployable deflecting or obstructing membrane designed to deflect or obstruct at least a portion of the secondary flow escaping from the radial extraction opening, when this deflecting or obstructing membrane is in a deployed configuration adopted when the movable structure is in the retreated thrust reversal position. Furthermore, in this deployed configuration, the membrane has a generally radially outwardly curved shape, and, defining at a base of the membrane, an air inlet opening in the membrane, said deployable deflecting or obstructing membrane extending between:
a membrane front portion forming a forward flap reaching to the base of the membrane; and
a membrane rear part forming a rearward flap reaching to the base of the membrane.

Thus, the invention proves to be advantageous in that it replaces all or part of the reverser deflecting cascades by one or more deflecting or obstructing membranes, capable of being deployed to carry out its counter-thrust, tangential flow, or obstruction function, when the movable structure adopts its retreated thrust reversal position. Such a membrane has the advantage of a small size in a non-deployed configuration, adopted when the movable structure is in the extended direct thrust position, while being capable of being extended radially outward substantially in its deployed position, for obtaining satisfactory performance in terms of counter-thrust.

The curved shape of the membrane makes it possible to better absorb the pressure forces to which the membrane is subjected. This results in a robust solution particularly adapted for installation in high air pressure zones of the reverser, while remaining lightweight, inexpensive, and readily repairable/replaceable.

Furthermore, the curved shape, for example dome type, offers multiple possibilities for varying the orientation of the outlet air flow, by producing one or more openings of suitable dimensions and locations through the membrane. In particular, it proves to be particularly easy to obtain a counter-thrust air flow with a substantial tangential component, for example by producing one or more air outlet openings on one of the two opposite circumferential faces of the membrane.

It is even conceivable to obtain an outlet air flow with zero axial component, or to result locally in total obstruction of the air where sought, by not providing any opening through the membrane.

Finally, it is noted that the invention is the result of technological research aimed at significantly improving aircraft performance and, in this respect, contributes to reducing the environmental impact of aircraft (decarbonisation).

The invention preferably provides for at least one of the following optional technical features, taken alone or in combination.

Preferably, the air inlet opening is delimited by an opening contour comprising:
a front opening contour portion, of rounded shape;
a rear opening contour portion, of rounded shape; and
at least one lateral opening contour portion, and preferably two lateral opening contour portions, arranged axially between the front and rear opening contour portions.

The particular shape of the air inlet opening contour also contributes to better absorption of the pressure forces to which the membrane is subjected.

Preferably, said front portion and said rear portion of the membrane each have a generally quarter-sphere shape, an intermediate portion of the membrane, having a generally half-cylinder shape, connecting the front and rear portions of the membrane.

This particular shape further improves the absorption of air pressure forces on the membrane. However, other curved shapes may be considered, without departing from the scope of the invention.

Preferably, in its deployed configuration, the membrane extends radially outward beyond the movable reverser cowl in the retreated thrust reversal position. In general, this makes it possible to improve counter-thrust performance.

Preferably, the reverser comprises a closed frame-shaped membrane support structure to which the base of the membrane is attached, the frame running along the air inlet opening contour in the membrane, and preferably having a circular, ellipse, oval, or oblong shape. This closed frame allows satisfactory absorption of the forces applied to the membrane.

Preferably, the opening contour is closed and continuous, or discontinuous, but preferably remaining in the same plane.

Preferably, the two lateral portions of the opening contour are rectilinear/straight, and/or the front and rear opening contour portions are each in a generally semi-circular shape.

Preferably, the membrane has at least one air outlet opening, for example produced at least partially through one of two opposite circumferential faces of the membrane. As mentioned above, this particular arrangement of the air outlet opening makes it possible to obtain an air flow with a tangential component, and therefore not purely axial. Other options may be considered, such as providing one or more air outlet openings on the forward/rearward flap, or on an upper surface of the curved membrane.

Preferably, the membrane has at least one air outlet opening produced at least partially through one of the two opposite circumferential faces of the membrane, as well as at least one air outlet opening produced at least partially through the other of the two opposite circumferential faces of the membrane. This particular arrangement of the air outlet openings makes it possible to obtain two air flows each with a tangential component, and in opposite directions. These openings and their resulting flows may be symmetrical, or asymmetrical.

Preferably, the membrane has several air outlet openings, each produced at least partially through one of two opposite circumferential faces of the membrane, and following each other axially, the air outlet openings preferably being slits, even more preferably parallel or substantially parallel to each other. The latter arrangement, which may optionally be provided on the two opposite circumferential faces, resembles, for example, shark gill slits.

Preferably, the membrane has an air outlet opening, produced at least partially through the other of the two opposite circumferential faces of the membrane, and taking the form of an axially extending slit. This arrangement makes it possible to properly balance the membrane in pressure when only one outlet flow is actually sought on the first circumferential face. Moreover, the flow which exits the second circumferential face, through the axially oriented slit, molds the membrane by passing above it radially outward, thus generating a negative pressure which advantageously helps hold the shape of the membrane.

This axially oriented slit solution is also applied regardless of the configuration of opening(s) on the opposite circumferential face of the membrane, always with a view to generating a negative pressure helping shape the deployed membrane.

Preferably, the reverser comprises at least two deployable deflecting or obstructing membranes, spaced apart from each other in the circumferential direction, of the same generally radially outwardly curved shape and of the same size, the two membranes being such that one comprises at least one air outlet opening and the other is devoid therefrom, or that one comprises at least one air outlet opening according to a first configuration, and the other comprises at least one air outlet opening according to a second configuration distinct from the first.

In other words, it is possible to start from a membrane of the same shape and same size, and then adapt the position/size of the outlet openings to adapt to the locally sought outlet flow direction within the reverser. This advantageously results in reduced industrial costs.

Preferably, said at least one deflecting or obstructing membrane is mounted on the fixed structure of the reverser.

The invention further relates to a nacelle for an aircraft propulsion assembly, comprising at least one fan cowl, as well as a thrust reverser as described above.

Finally, the invention also relates to an aircraft propulsion assembly, comprising a turbomachine and such a nacelle.

Among the other optional features of the invention, the presence is noted of at least one other deployable deflecting membrane designed to deflect said at least a portion of the secondary flow escaping from the radial extraction opening, when this deflecting membrane is in a deployed configuration adopted when the movable structure is in the retreated thrust reversal position, and in this deployed configuration, said at least one deflecting membrane extends radially outward beyond the movable reverser cowl in the retreated thrust reversal position. Here again, such a deflecting membrane has the advantage of a small size in a non-deployed configuration, adopted when the movable structure is in the extended direct thrust position, while being capable of being extended radially outward substantially in its deployed position, for obtaining satisfactory performance in terms of counter-thrust.

The solution, as proposed, makes it possible to reduce the axial size of the reverser, because the proposed membrane(s) deflect the flow preferably forward, by channeling it towards an ejection section preferably substantially perpendicular to the outlet plane of the membranes. Thus, the flow surface area is always substantially equal to the outlet cross-section of the membranes, whereas in the case of conventional cascades, ejection is performed obliquely relative to the outer plane of the cascade. In the case of cascades, the further forward the jet is deflected, the smaller the flow surface area of the cascade. Also, to obtain a compatible engine flow rate, the cascades must then be lengthened axially, with a significant impact on the overall size of the reverser.

In the case of a membrane, its geometry orients the flow, but its outlet cross-section causes rectification of the flow, while remaining perpendicular to the outlet velocity of this flow.

With this solution, it is thus possible to tilt the jet more to make it as parallel as possible to the axial direction, and therefore increase its counter-thrust performance, without reducing the flow surface area. Consequently, the length of the reverser is determined by the length of any deflecting grids retained, depending on whether these are completely or partially replaced by these membranes.

This leads to an increase in mass and drag, which in turn leads to an improvement in specific consumption. Moreover, the general performance of the propulsion assembly is increased, thanks to the greater freedom in the choice of aerodynamic shapes of the reverser in direct jet, these shapes remaining more or less determined by the need to house the deflecting cascades in the reverser in the direct thrust configuration.

It is noted that this/these other deployable deflecting membrane(s) are reverser membranes capable of generating an outlet flow with a non-zero forward axial component, and/or a circumferential outlet flow with a zero axial component. However, for this latter functionality, the membranes with a generally curved shape disclosed above, and objects of the present invention, are preferred.

Among the other optional features of the invention, the presence is also noted of at least one other deployable deflecting membrane designed to deflect at least a portion of the secondary flow escaping from the radial extraction opening, when this deflecting membrane is in a deployed configuration adopted when the movable structure is in the retreated thrust reversal position, the reverser comprising a membrane support structure. In this deployed configuration, the membrane has a generally radially outwardly curved shape, extending between a front membrane end secured to a front reinforcement of the support structure, and a rear membrane end secured to a rear reinforcement of the support structure. In addition, in its deployed configuration, the deflecting membrane extends radially outward without going beyond the movable reverser cowl in the retreated thrust reversal position.

Thus, this other type of membrane also has the advantage of a small size in the non-deployed configuration, adopted when the movable structure is in the extended direct thrust position. The simple shape of the membrane makes it economical, and its relatively low radially outward extension makes it particularly well suited for installation in low air pressure zones of the reverser. In other words, this membrane remains lightweight, inexpensive, and readily repairable/replaceable.

Furthermore, the curved shape, for example of the flattened arch type, offers several options for varying the orientation of the outlet air flow. In particular, it proves to be particularly easy to obtain a counter-thrust air flow with a substantial tangential component, or an outlet air flow with a zero axial component.

Other advantages and features of the invention will become apparent in the non-limiting detailed description below.

### BRIEF DESCRIPTION OF THE DRAWINGS

The following detailed description refers to the appended drawings wherein:

FIG. 1 is a schematic longitudinal sectional half-view of a propulsion assembly comprising a thrust reverser shown in a direct thrust configuration;

FIG. 2 is a schematic longitudinal sectional half-view of the reverser equipping the propulsion assembly shown in FIG. 1, with the reverser presented in the form of a first preferred embodiment of the invention, and shown in a direct thrust configuration;

FIG. 3 is a schematic longitudinal sectional half-view similar to that of the previous figure, with the reverser shown in an intermediate configuration between the direct thrust configuration, and the thrust reversal configuration; and

FIG. 4 is a longitudinal sectional half-view similar to that of the previous figure, with the reverser shown in the thrust reversal configuration;

FIG. 5 is a perspective view showing several deflecting membranes of the reverser shown in the previous figure, in a deployed configuration of the membrane, the membrane being presented in the form of a first membrane type;

FIG. 5A is a longitudinal half-sectional view showing the aerodynamic continuity between the deflection edge of the fixed structure of the reverser, and the support frame of the deflecting membrane;

FIG. 6 is a partial perspective view of the reverser, showing deflecting membranes according to the first type, but also according to a second type and according to a third type, these membranes being shown in the deployed thrust reversal configuration;

FIG. 7 is a perspective view of one of the deflecting membranes according to the second type, in a deployed thrust reversal configuration;

FIG. 8 is a radial top view of the membrane support structure shown in the previous figure;

FIG. 9 is a radial top view of the membrane shown in FIG. 7;

FIG. 10 is a radial top view similar to the previous one, with the membrane presented in the form of an alternative embodiment;

FIG. 11 is a perspective view similar to that of FIG. 7, with the membrane presented in the form of an alternative embodiment;

FIG. 12 is a lateral view of the membrane shown in the previous figure;

FIG. 13 is a perspective view similar to that of FIG. 7, with the membrane presented in the form of an alternative embodiment;

FIG. 14 is a perspective view similar to that of FIG. 7, with the membrane presented in the form of another alternative embodiment;

FIG. 15 is a perspective view similar to that of FIG. 7, with the membrane presented in the form of another alternative embodiment;

FIG. 16 is a perspective view similar to that of FIG. 7, with the membrane presented in the form of another alternative embodiment;

FIG. 17 is a perspective view similar to that of FIG. 7, with the membrane presented in the form of another alternative embodiment;

FIG. 18 is a perspective view of one of the deflecting membranes according to the third type, in a deployed thrust reversal configuration;

FIG. 19 is a perspective view of the membrane shown in the previous figure, from another angle;

FIG. 20 is a radial top view of the membrane support structure shown in the previous figure;

FIG. 21 is a perspective view similar to that of FIG. 18, with the membrane presented in the form of an alternative embodiment;

FIG. 22 is a perspective view of the membrane shown in the previous figure, from another angle;

FIG. 23 is a perspective view similar to that of FIG. 21, with the membrane presented in the form of an alternative embodiment;

FIG. 24 is a perspective view of the membrane shown in the previous figure, from another angle.

### DETAILED DESCRIPTION OF SOME EMBODIMENTS

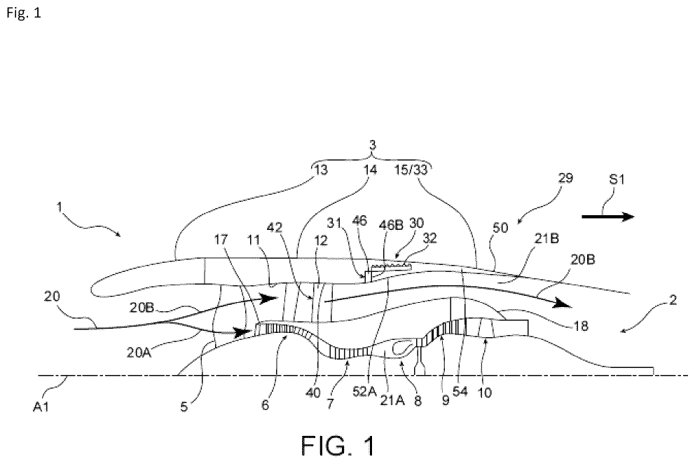

An aircraft propulsion assembly 1 is shown in FIG. 1, having a longitudinal central axis A1.

Subsequently, the terms “upstream” and “downstream” are defined relative to a general direction S1 of flow of gases through the propulsion assembly 1, along the axis A1 when it is generating direct thrust. These “upstream” and “downstream” terms could be substituted by the terms “front” and “rear”, respectively, with the same meaning.

The propulsion assembly 1 comprises a turbine engine 2, a nacelle 3 as well as a mast (not shown), intended to connect the propulsion assembly 1 to a wing (not shown) of the aircraft.

The turbine engine 2 is, in this example, a bypass, twin-spool turbojet engine comprising, from front to back, a fan 5, a low-pressure compressor 6, a high-pressure compressor 7, a combustion chamber 8, a high-pressure turbine 9 and a low-pressure turbine 10. The compressors 6 and 7, the combustion chamber 8 and the turbines 9 and 10 form a gas generator. The turbojet engine 2 is provided with a fan casing 11 connected to the gas generator by structural arms 12.

The nacelle 3 comprises a front section forming an air inlet 13, a middle section that comprises two fan cowls 14 enveloping the fan casing 11, and a rear section 15. In operation, an air flow 20 enters the propulsion assembly 1 through the air inlet 13, passes through the fan 5 then splits into a primary flow 20A and a secondary flow 20B. The primary flow 20A flows into a primary gas circulation flow path 21A passing through the gas generator. The secondary flow 20B flows into a secondary flow path 21B surrounding the gas generator. The secondary flow path 21B is delimited radially inward by a fixed inner shroud that surrounds the gas generator. In this example, the fixed inner shroud comprises a first segment 17 belonging to the middle section 14, and a second segment 18 extending rearward from the first segment 17, so as to form a portion of the rear section 15. This second segment 18 is an integral part of a fixed structure of a thrust reverser which will be described below. This same segment will subsequently be referred to as the radially inner wall 18 delimiting the secondary flow path 21B.

Radially outward, the secondary flow path 21B is delimited by the fan casing 11, and, in the configuration of FIG. 1, by one or more movable reverser cowls 33 forming a portion of the rear section 15 of the nacelle 3, and which will be described later. More precisely, between the fan casing 11 and the reverser cowls 33, an outer shell 40 of an intermediate casing 42 is provided, the latter comprising the aforementioned structural arms 12, the radially outer end of which is attached to this shell 40. It therefore also participates in delimiting the secondary flow path 21B radially outward, by being located in the axial extension downstream of the fan casing 11.

The nacelle 3 therefore comprises a thrust reverser 30 (only shown schematically and partially in FIG. 1) centered on the axis A1 and comprising, on the one hand, a fixed structure 31 secured to the fan casing 11, and, on the other hand, a movable structure 29 relative to the fixed structure 31. The fixed structure 31 comprises, for example, a front frame 46 which fixedly connects it to the fan casing 11, preferably via a knife-edge assembly located downstream of the outer shell 11. This front frame 46 contains a profiled aerodynamic portion called the deflection edge 46B, which guides the reverse jet flow.

In this preferred embodiment, the fixed structure 31 also comprises several deployable deflecting membranes 32, one of which is shown schematically in a non-deployed configuration in FIG. 1.

Moreover, the movable structure 29 comprises the aforementioned movable reverser cowls 33, for example two cowls 33 each extending over an angular amplitude of about 180°. This two-cowl configuration 33 is particularly well suited in the case of a nacelle design wherein the cowls/walls 18 are also mounted articulated, the reverser 30 then having a so-called “D-Duct” architecture. In this architecture, the cowls 18, 33 are connected so as to open/close simultaneously during maintenance operations on the engine. Nevertheless, other architectures are possible, such as a so-called “C-Duct” architecture, or a so-called “O-Duct” architecture.

Each reverser cowl 33 comprises a radially outer wall 50 forming an outer aerodynamic surface of the nacelle, as well as a radially inner wall 52 participating in delimiting the secondary flow path 21B radially outward. This wall 52 is located in the downstream continuity of the deflection edge 46B, in the direct thrust configuration. The two walls 50, 52 define a housing 54 open axially at the upstream end of the reverser cowl 33, and wherein at least a portion of the deflecting membranes 32 is located in the direct thrust configuration.

FIG. 1 shows the reverser 30 in an extended thrust configuration, referred to as “direct jet”, corresponding to a standard flight configuration. In this configuration, the cowls 33 of the movable structure 29 are in a closed position, referred to as extended “direct jet” or thrust position, wherein these reverser cowls 33 are bearing on the fixed structure 31, in particular on the deflection edge 46B forming an integral part of the latter. Indeed, in the direct thrust configuration, the upstream end 52A of the radially inner wall 52 of each cowl 33 is axially bearing against the deflection edge 46B.

The movable structure 29 can thus be moved in translation relative to the fixed structure 31 along the axis A1 of the reverser, between the extended direct thrust position shown in FIG. 1, and a retreated thrust reversal position which will be described later. In the extended direct thrust position of the movable structure 29, the deflecting membrane(s) 32 in the retreated/non-deployed configuration are arranged in the housing 54 of the reverser cowls 33, being separated from the secondary flow path 21B by the radially inner wall 52 of these sliding cowls 33. This wall 52, forming the outer wall of the secondary flow path, is also referred to as the acoustic inner panel.

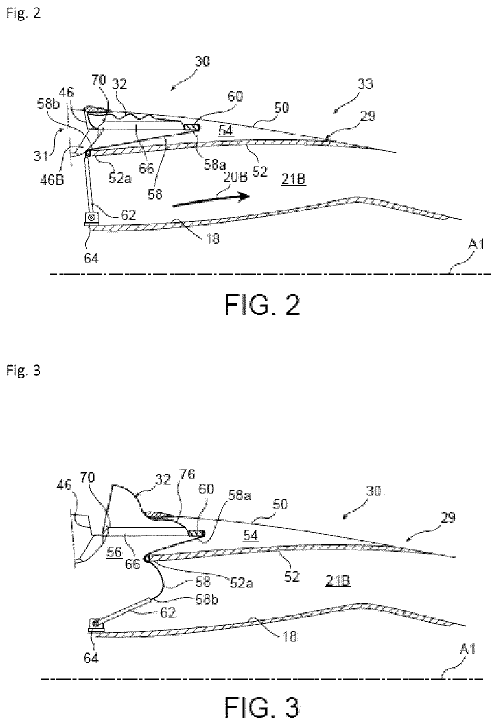

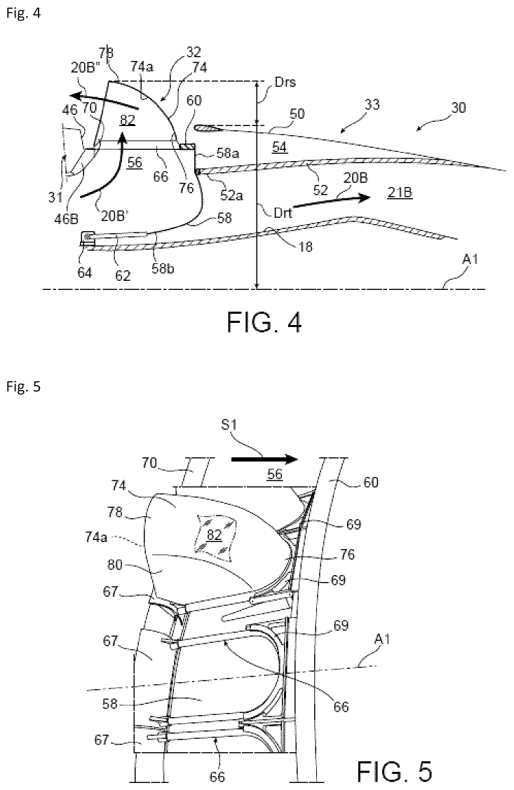

The direct thrust configuration is also shown in FIG. 2, whereas the retreated thrust reversal position of the movable structure 29 is shown in FIG. 4. FIG. 3 shows the reverser in an intermediate position between the positions of FIGS. 2 and 4. All of FIGS. 1 to 5A show a preferred embodiment of the present invention.

In FIG. 4, it is shown that the deflection edge 46B and the upstream end of the movable cowl 33 axially delimit between them, on the secondary flow path 21B, a radial extraction opening 56 of at least a portion 20B′ of the secondary flow 20B. The opening 56 of the secondary flow path 21B is therefore delimited upstream by the deflection edge 46B, which, conventionally, flares radially outward in the rearward direction, to delimit an air flow 20B′ intended to pass through this opening 56 when the movable system is in this retreated thrust reversal position. In other words, the deflection edge 46B, here embodied in a rigid manner, moves progressively away from the axis A1 from front to rear, to guide/deflect the air through the opening 56 and toward the deployable deflecting membrane 32, in the thrust reversal configuration. Conversely, this opening 56 of the secondary flow path 21B is particularly delimited downstream by the upstream end 52A of the radially inner portion 52 of the cowl 33, but also by the upstream end of the radially outer wall 50 of this same cowl. As will be described hereinafter, FIG. 5A shows in more detail the role of the solid extension of the deflection edge included in the solid structure bearing the membrane 32, and its interaction with the geometry of the latter in order to obtain the most homogeneous flow possible at the reverser outlet.

In order to force at least a portion 20B′ of the secondary flow 20B toward the opening 56, the reverser 30 comprises one or more sealing membranes 58. Subsequently, a single membrane 58 will be described, the assembly of which has for example an angular amplitude identical or similar to that of the assembly of deflecting membranes 32 which will be described hereinafter, and which is located in the same axial and radial plane of the propulsion assembly. Thus, a plurality of circumferentially adjacent membranes 58 can be provided within the secondary flow path 21B. Nevertheless, the angular extent of the sealing membrane 58 may be greater than that of the deflecting membrane 32, without leaving the scope of the invention.

The membrane 58 may be made of a material known to a person skilled in the art for this type of application. For example, it may be an unimpregnated fabric, for example aramid fibers. The membrane 58 may also be produced using a composite material, the matrix of which is particularly flexible, for example made of aliphatic polyurethane, which allows use under different temperature conditions, in particular under lower temperatures in the case of an aliphatic polyurethane membrane than in the case of a silicone membrane. The matrix results in a low capacity to bend back and the behavior of the structure obtained is indeed that of a membrane. One of the major properties of this sealing membrane 58 is that it is able to be folded perfectly reversibly (elastically or by sliding fibers) with a very small radius of curvature relative to the surface thereof, and that it has a very small thickness, for example in the order of 0.1 to 3 mm. For information purposes, it is observed that this membrane 58 behaves like a boat sail or a parachute/flying wing when it is pressurized.

A first end 58a of the sealing membrane 58 is attached to a rear support frame 60 belonging to the fixed structure 31 and running in the circumferential direction, this frame being located in or in the vicinity of a rear axial end of the opening 56 and serving to support the membranes 32. Similarly, a front support frame 70 is provided, also belonging to the fixed structure 31 and running in the circumferential direction, this front frame 70 being located in or in the vicinity of a front axial end of the opening 56 and serving to support the membranes 32.

Furthermore, a second end 58b of the sealing membrane 58, opposite the first membrane end 58a, is attached to the wall 18. It is noted that the first end 58a may be attached to the rear of the rear support frame 60 as shown in the figures, or to the front of this same support.

For this purpose, connecting rods 62 may be used, of which a first end of each is mounted on the wall 18, preferably via a pivot or ball joint connection 64. This connection 64 may be produced using a fitting attached to the fixed wall 18 and cooperating with the first end 62a of the connecting rod.

The connecting rods 62 are circumferentially spaced apart from each other within the secondary flow path 21B, and the number thereof may vary.

Each connecting rod 62 is designed to move from a radially protruding position in the secondary flow path 21B, which position is shown in FIG. 2 and adopted when the movable structure 29 occupies the extended direct thrust position thereof, into a retreated position downstream, shown in FIG. 4 and adopted when the movable structure 29 occupies the retreated thrust reversal position thereof. In the protruding position, each connecting rod 62 may adopt a radial or substantially radial orientation relative to the axis A1, whereas in the folded position, each connecting rod may adopt an axial or substantially axial orientation.

Elastic means, referred to as elastic return means (not shown), tend to tilt each connecting rod 62 to tilt towards the retreated/reclined position thereof in FIG. 4, in particular when the connecting rod is in the protruding position thereof corresponding to the flight position of the reverser. Thus, at the start of deployment of the reverser, each connecting rod 62 exerts a rearward and downward thrust on the membrane 58 which pulls it into the flow path so that the flow that rushes into the housing 54 at the start of transit does not jam the membrane in this housing 54 of the fan cowl 33.

The second end of each connecting rod 62, opposite the first end, can be connected directly to the second end 58b of the membrane 58. Nevertheless, other preferred solutions are retained, such as those aiming to integrate cables and/or reinforcement straps within the attachment means of the membrane 58 on its associated elements 18, 60.

It is noted that the connecting rods 62 are axially positioned so that the trajectory of their second end is tangent or substantially tangent to the inner surface of the acoustic panel 52 in its front portion, or so that the trajectory is downward in the flow path.

As seen in FIG. 2, when the movable structure 29 occupies its extended direct thrust position, at least a portion of the sealing membrane 58 is arranged radially outward relative to the radially inner wall 52 of the reverser cowl 33, in the housing 54. Consequently, when the movable structure 29 adopts its extended direct thrust position, the second end 58b of the sealing membrane 58 is pinched between the upstream end 52a of the wall 52, and the deflection edge 46B. In order to avoid possible damage to the membrane 58 due to this pinching, the deflection edge 46B may locally have a notch of a shape adapted to receive the upstream end 52A of the wall 52. Thus, the membrane 58 is also pressed into this notch of the deflection edge 46B, by bearing on the upstream end of the wall 52.

As can be seen in FIGS. 3 and 4, when the movable structure 29 moves and occupies its retreated thrust reversal position at the end of this movement, the sealing membrane 58 finds itself partially bearing against the upstream end 52a of the radially inner wall 52 of the reverser cowl, therefore corresponding to the acoustic panel. More specifically, during the rearward movement of the movable structure 29, the membrane 58 slides on this upstream end 52A of the radially inner wall 52.

In the retreated thrust reversal position of FIG. 4, the membrane 58 is therefore axially bearing downstream against the upstream end 52A. It should be noted that, depending on the extent of the axial travel of the reverser, the membrane 58 may no longer be in contact with the inner acoustic panel 52 in the fully deployed position of the reverser, where the cowl 33 is in the most retreated position thereof. The contact option corresponds to a minimized travel of the reverser, whereas the non-contact option generally corresponds to a smoother membrane shape in the reverse jet configuration, therefore performing better from an aerodynamic point of view.

Thus, the portion of the membrane 58 that is located radially outward relative to the bearing zone thereof on the wall 52 seals a portion of the axial opening upstream of the housing 54, whereas the other portion located radially inward seals at least a portion of the secondary flow path 21B, thereby deflecting at least a portion 20B′ of the secondary flow 20B toward the opening 56 in the direction of the deployable deflecting membrane 32. The material used to produce the membrane 32 is any one of those already mentioned above for producing the sealing membrane 58.

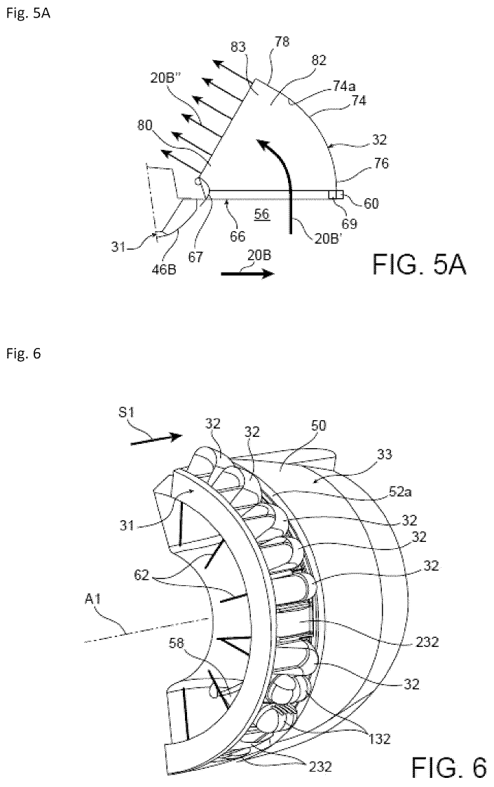

As discussed above, in this preferred embodiment, several deflecting membranes follow each other within the reverser in the circumferential direction, as seen in FIG. 6. More specifically, three types of membranes are implemented here in the reverser, the first type corresponding to the deflecting membrane 32 detailed in FIGS. 1 to 5, and essentially intended to generate counter-thrust forces. A second membrane type, specific to the present invention, makes it possible to generate counter-thrust forces as well as air outlet flows with a non-zero tangential component, and may even be provided so as to generate an obstruction of the flow drawn from the secondary flow. These are the membranes referenced 132 in the figures. Finally, a third membrane type also makes it possible to generate counter-thrust forces but also air outlet flows with a non-zero tangential component. These are the membranes referenced 232 in the figures.

As regards the membranes 32 of the first type, each of these corresponds to a downstream deflecting membrane which is attached to a membrane support structure 66, here an axially oriented generally U-shaped open frame, open to the front as shown in FIG. 5. The base of the membrane 32 is attached to the structure 66, along its entire length, for example using a simple lap or using other conventional techniques.

A front interface part 67 creates the mechanical connection between the two free ends of the U-shaped frame 66 and the front support frame 70, whereas a rear interface part 69 creates the mechanical connection between the rounded base of the U-shaped frame 66, and the rear support frame 60.

It is noted that the axial length of the frame 66 is identical or substantially identical to the axial length of the opening 56.

More specifically, the deflecting membrane 32 comprises a main deflection portion 74, of which a concave active deflection surface 74a has a leading edge 76 attached to the rounded base of the U-shaped frame 66, this leading edge therefore being located at a rear axial end of the radial extraction opening 56.

FIG. 5A shows that the front interface part 67 has a solid extension function of the deflection edge 46B, since it has a profiled shape located in the aerodynamic continuity of the latter. This bypass zone with a small radius of curvature, formed by the front interface part 67, makes it possible to obtain a homogeneous directional outlet jet substantially perpendicular to the trailing outlet section of the main deflection portion 74 of the membrane 32, located at a trailing edge 78 thereof.

Moreover, at this trailing edge 78, it is noted that the membrane 32 can be equipped with a fabric reinforcement 83 shown in FIG. 5A, particularly to reinforce the parallelism of its radial flanks 80.

In operation, the secondary flow 20B transits via the secondary flow path 21B, and abuts at least partially against the deployed sealing membrane 58, which forces a portion 20B′ of this flow to pass through the opening 56, and therefore to pass through the opening defined internally by the frame 66. The flow of the flow portion 20B′ through the extraction opening 56 thus has the effect of pressurizing the concave active deflection surface 74a, and therefore deploying the deflecting membrane 32 to its fully deployed configuration shown in FIGS. 4 and 5 and 5A.

The main deflection portion 74, and its concave active inner deflection surface 74a, have the same curved shape which makes it possible to progressively rectify the flow portion 20B′ initially of radial or substantially radial orientation exiting the opening 56, to achieve a forward-oriented counter-thrust flow 20B″, for example with a significant component parallel to the axis A1. This direction of the counter-thrust flow 20B″, which may be adapted according to the needs encountered, is substantially parallel to a tangent to the trailing edge 78 of the main deflection portion 74 and its concave active inner deflection surface 74a. The main portion 74 and its active inner surface 74a may for example extend in the form of an arc of a circle or the like, preferably over an angular extent between 75 and 90°. With this first type of membrane 32, a counter-thrust function is preferably sought, therefore the air outlet flow 20B″ used for this counter-thrust preferably has a zero tangential component. Only an axial component, along which the U-shaped frame 66 is oriented, and optionally a radial component are present.

In FIG. 2, the membrane 32 is shown in the retreated/non-deployed configuration, as adopted when the movable structure 29 of the reverser is in the extended direct thrust position. The retreated membrane 32 is thus located in the housing 54 of the movable reverser cowl 33, being radially covered by the wall 50 of this cowl, and being preferably arranged radially outward relative to the likewise non-deployed sealing membrane 58.

The membrane 32 also comprises, circumferentially on either side of its main deflection portion 74, respectively two radial flanks 80 seen in FIG. 5. The inner surface of these two radial flanks 80 jointly delimit, with the concave active inner deflection surface 74a of the main portion 74, a forward deflection channel 82 of the portion 20B′ of the secondary flow escaping from the radial extraction opening 56, to subsequently generate the counter-thrust flow 20B″. With the presence of these radial flanks 80 which run along and which are respectively attached to the two lateral branches of the U-shaped frame 66, the membrane 32 adopts a general “hood” shape, of which the channel 82 that it delimits internally has a forward curved shape, switching from a radial or substantially radial orientation to an axial or substantially axial orientation. For this purpose, each axial flank 80 of the membrane 32 adopts a quasi-planar generally triangular shape, with one of its arched sides, following the concave shape of the active deflection surface 74a.

One of the specificities of this first type of membrane 32 therefore consists in providing a shape making it possible to deflect the portion of the flow 20B′ escaping from the opening 56 forward, when this deflecting membrane is in the deployed configuration of FIG. 4. In addition, for higher reverser performance and for a smaller reverser size, in this deployed configuration, the downstream membrane 32 extends radially outward beyond the movable reverser cowl 33 in the retreated thrust reversal position. The membrane 32 may thus extend beyond the wall 50 of the cowl 33 for a protruding radial distance “Drs”.

It is noted that the meridian cross-section of the membrane 32 may advantageously be a circle. This membrane then has a height equal to the axial length of the slot formed by the frame 66 supporting the hood-shaped membrane. On the other hand, it may be advantageous to transform this shape into an elliptical sector, more flattened than a circular sector, in order to reduce the flow cross-section slightly when approaching the exit section. This creates a slightly accelerated and more stable flow. Very preferably, the membrane 32 protrudes from the aerodynamic lines of the wall 50 by several centimeters in the radial direction. This protruding radial distance “Drs” may be approximately in the order of 50% to 90% of the radial height of the flow path 21B in line with the reverser, for example in the plane where the dimension line of the reference “Drt” in FIG. 4 is located, this reference corresponding to the total radial distance of the reverser taken radially between the axis A1 and the trailing edge 78 of the main deflection portion 74 in the deployed configuration.

In the preferred embodiment described above, the deflecting membrane 32 defines a single deflection channel 82. Nevertheless, according to an alternative embodiment, the deflection channel 82 may delimit, using intermediate radial flanks parallel to the radial flanks 80 and located between the latter, several deflection compartments circumferentially separated from each other. In this scenario, the main deflection portion 74 may remain of continuous shape in the circumferential direction, or may be in the form of successive lobes in the circumferential direction, each new lobe starting at the radially outer end of each radial flank.

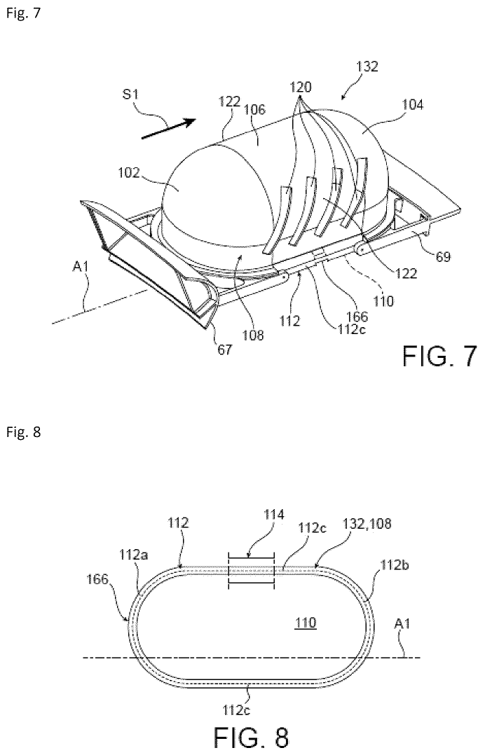

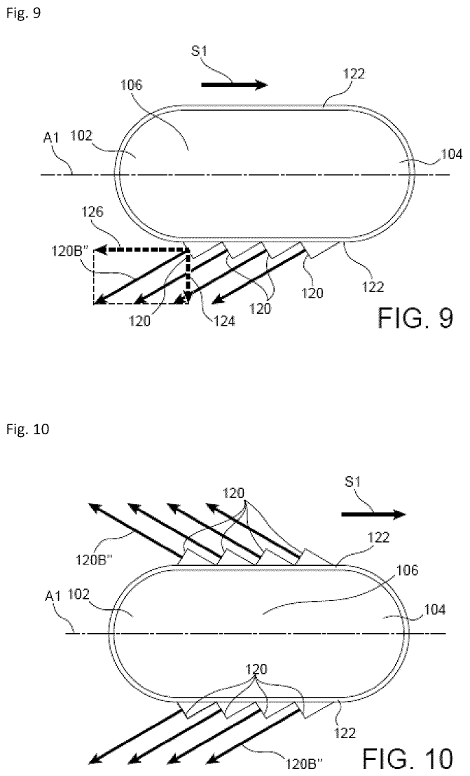

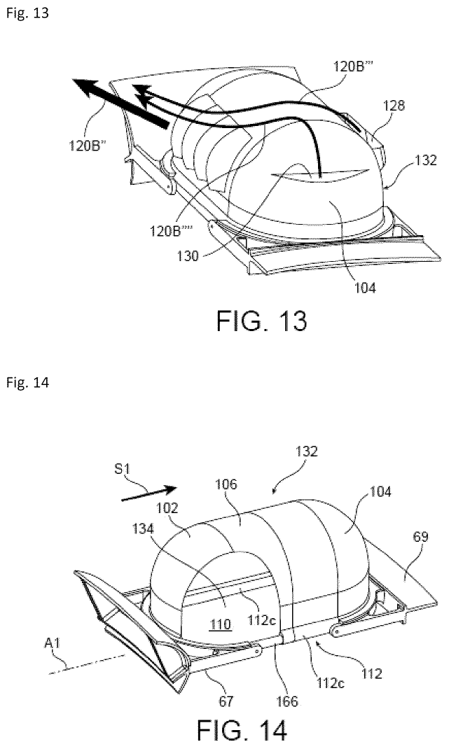

FIGS. 7 to 17 show different membranes 132 of the second type, capable of deploying to carry out the counter-thrust, tangential flow or obstruction function, when the movable structure adopts its retreated thrust reversal position. This second membrane type, specific to the present invention, has a curved shape and an air inlet opening contour which make it possible to satisfactorily absorb significant pressure forces applied to the membrane. This second type of membrane 132 thus proves to be particularly adapted for installation in high air pressure zones of the reverser, i.e. the most loaded zones.

Unlike the first membrane type described above, the second membrane type is preferably retained to locally obtain a lateral deflection of the air outlet flow, with a non-zero, or even substantial, tangential component. In this respect, it is noted that this tangential component may be sought in order to limit air projections toward the aircraft fuselage, and/or in order to avoid air reinjection phenomena within the turbomachine or the adjacent turbomachine.

Firstly, with reference to FIGS. 7 to 9, a membrane 132 is shown which, in the deployed configuration, has a generally radially outwardly curved shape, here dome-shaped extending lengthwise in the axial direction.

More specifically, the deployable deflecting membrane 132 has a front portion 102 forming a forward flap reaching to the base of the membrane, and preferably adopting a generally quarter-sphere shape opening radially inward and axially rearward. Similarly, the membrane 132 comprises a rear portion 104 forming a rearward flap reaching to the base of the membrane, and also preferably adopting a generally quarter-sphere shape opening radially inward, and axially forward. The two opposite flaps form a substantial singularity of the membrane 132, regardless of the general shape selected. The membrane 132 therefore extends between its front membrane portion 102 and its rear membrane portion 104.

Furthermore, an intermediate portion 106 with a generally axially and radially inwardly open half-cylinder shape, connects the front and rear portions 102, 104 of the membrane.

From a radial amplitude point of view, as with the first type of membrane 32, the deployed membrane 132 preferably extends radially outward beyond the movable reverser cowl in the retreated thrust reversal position. By protruding in this way from the aerodynamic lines of the reverser in the thrust reversal configuration, the efficiency of the laterally deflected air flow exiting this membrane is advantageously increased. The membrane 132 defines, at a base 108 thereof, an air inlet opening 110 in the membrane. This opening 110 is delimited by an opening contour 112, here closed, and which cooperates with a closed frame-shaped membrane support structure 166, here of oblong shape. The base 108 is thus attached to the frame 166, which runs along the air inlet opening contour 112. Here also, this attachment may be carried out by a lap 114, or any other technique deemed appropriate.

The opening contour 112, of the same oblong shape as that of the frame 166, is closed and continuous. It comprises several adjacent portions, among which:
a front opening contour portion 112a, of rounded shape, preferably semicircular, cooperating with a front portion of the same shape of the frame 166;
a rear opening contour portion 112b, of rounded shape, preferably semicircular, cooperating with a rear portion of the same shape of the frame 166;
two lateral opening contour portions 112c, preferably rectilinear/straight, arranged axially between the front and rear opening contour portions 112a, 112b, and cooperating respectively with two corresponding rectilinear/straight axial reinforcements of the support 166.

In this respect, it is noted that the front and rear opening contour portions 112a, 112b may be offset from each other along the axis A1. However, the membrane may not only extend from front to rear while being parallel or substantially parallel to the axis A1, but also extend while having a circumferential component, and therefore not being parallel to the axis A1. In the latter case, the front and rear opening contour portions 112a, 112b are thus offset from each other along the inclined axis of the membrane, having the circumferential component mentioned above.

Furthermore, the opening contour 112, and the frame 166, could have a different shape than the oblong shape. For example, the lateral opening contour portions 112c could be curved such that the opening contour 112 has a generally oval shape, or the lateral opening contour portions 112c could be rounded such that the opening contour 112 has a generally circular shape.

The opening contour 112 is preferably inscribed in an axial and tangential plane, and is located in the radial extraction opening mentioned above. Here also, it is noted that the axial length of the frame 166 is identical or substantially identical to the axial length of this radial air extraction opening 56. Moreover, it is also noted that the membrane 132 has the same type of cooperation with a sealing membrane 58 in the secondary flow, as that described above for the membrane 32. Similarly, its support structure 166 cooperates with the same type of front and rear interface parts 67, 69, the latter also being attached to the front and rear membrane support frames 70, 60.

In the embodiment shown in FIGS. 7 to 9, the membrane 132 has several air outlet openings 120, each produced at least partially through one of the two opposite circumferential faces 122 of the membrane. These air outlet openings 120 follow each other axially, preferably in the form of mutually parallel or substantially parallel slits.

These slits 120 may each extend axially rearward, moving radially outward. They thus resemble shark gill slits, being provided here in a number ranging from two to six slots following each other in the axial direction.

By arranging the slits 120 on one of the two opposite circumferential faces 122 of the dome-shaped membrane, the resulting air outlet flow 120B″ may readily have a non-zero tangential component 124 to provide the desired lateral deflection function, as well as an also non-zero axial component 126 in order to contribute to the counter-thrust, and preferably a zero or substantially zero radial component for superior efficiency of the effects mentioned above.

The lateral deflection angle of the air outlet flow 120B″, relative to the axial direction, may for example be in the order of 30°, 45° or 60°. Some air outlet opening embodiments could even result in a 90° lateral deflection, conveying the air outlet flow 120B″ with a zero axial component.

In the embodiment shown in FIGS. 7 to 9, the openings 120 are arranged mainly on the semi-cylindrical intermediate portion 106, but they could also extend partially on the front and rear portions 102 of a generally quarter-sphere shape.

As shown in FIG. 10, an analogous arrangement of openings 120, or even symmetrical relative to a radial and axial medial plane of the membrane 132, could be provided on the opposite circumferential face 122.

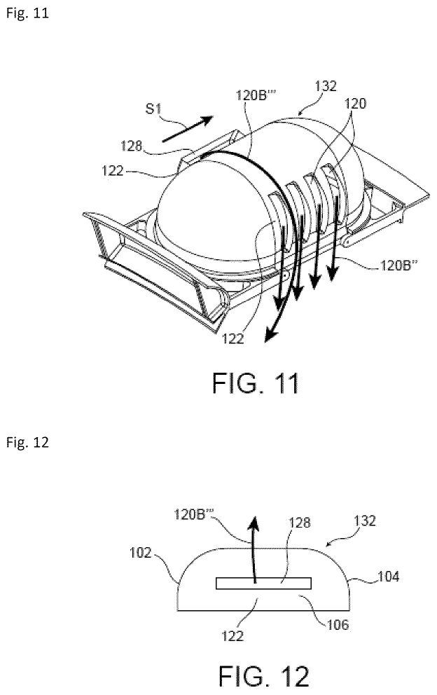

According to an alternative shown in FIGS. 11 and 12, on this circumferential face opposite that which comprises the openings 122 following each other axially, an axially extending slit-shaped air outlet opening 128 is provided, through the semi-cylindrical intermediate portion 106, and optionally extending on one and/or the other of the front and rear portions 102. This arrangement makes it possible to correctly balance the membrane in pressure, with two laterally exiting flows from the two opposite sides of this membrane. In addition, the flow 120B″ which exits through the axially oriented slit 128 molds the membrane by passing radially outwardly over it, thus generating a negative pressure which advantageously helps hold the shape of this membrane. It then joins the outlet air flow 120B″ from the axial slits 120.

In the same aim, an opening 130 may be provided on the rear membrane portion 104, extending substantially circumferentially. The outlet flow 120B″″′ also helps shape the membrane, by negative pressure, before joining the outlet air flow 120B″.

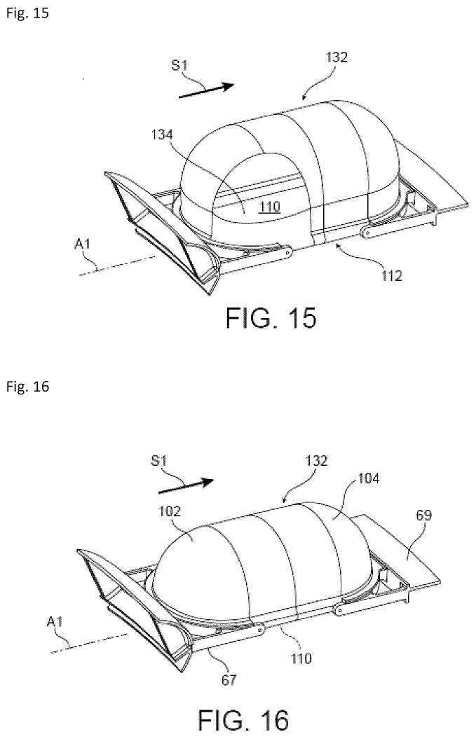

FIG. 14 shows an alternative wherein a lateral opening 134 with a larger surface area crosses one of the opposite circumferential faces 122 of the membrane. This crossing is performed up to the opening contour 112, rendering the latter discontinuous/interrupted at one of the two lateral opening contour portions 112c. The extended position of the opening 134 on the membrane results in limiting of the deflection angle of the air outlet flow, but this position may of course be adapted according to the sought deflection angle. FIG. 15 is a similar alternative, wherein the air outlet opening 134 does not extend to the contour 112 of the air inlet opening 110 in the membrane, thus keeping the contour 112 continuous/uninterrupted.

FIG. 16 shows another variation of the principle of the dome-shaped second membrane type, wherein it is simply sought to obstruct the flow entering the membrane 132, from the opening 110. No outlet opening is made through the membrane, such that no outlet flow is generated locally within the reverser.

As can be seen in FIG. 6, the reverser may comprise several membranes 132 of this second type, circumferentially spaced apart from each other and having different outlet opening configurations.

In this example, it consists of a membrane 132 according to the configuration of FIG. 7, followed in the counterclockwise direction by a membrane 132 according to the configuration of FIG. 14. This results in an industrial advantage, given that these membranes can preferably be obtained from identical membranes, i.e. having the same shape and size, preferably those of the closed membrane of FIG. 16, and which are subsequently perforated with the desired openings.

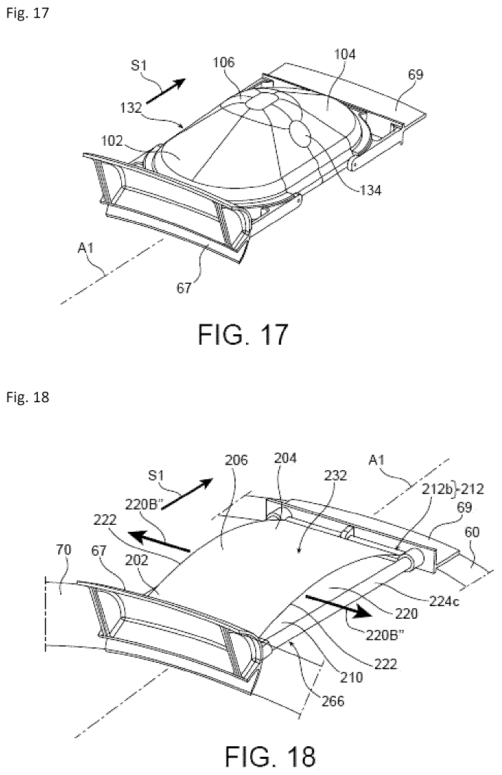

Other generally curved shapes than that shown on the membranes of FIGS. 7 to 16 may be provided, such as that of FIG. 17 wherein the membrane 132 is slightly more flattened in the radial direction. More specifically, its three portions 102, 104, 106 are each more radially flattened.

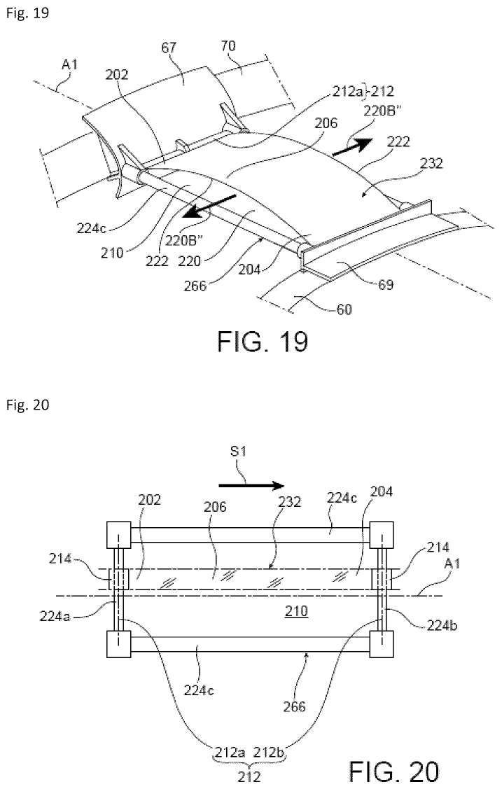

FIGS. 18 to 24 show different membranes 232 of the third type, capable of deploying to carry out the counter-thrust or tangential flow function. This third membrane type has a domed shape and an air inlet opening contour which make it possible to satisfactorily absorb lower pressure forces than those applied to the second membrane type described above. This third type of membrane 232 thus proves to be particularly adapted for installation in the low air pressure zones of the reverser, i.e. the least loaded zones. In exchange, its embodiment is simpler, and its cost reduced.

Unlike the first membrane type described above, the third membrane type is preferably retained to locally obtain a lateral deflection of the air outlet flow, with a non-zero, or even substantial, tangential component, up to optionally having a zero axial component. In this respect, it is noted that this tangential component may be sought in order to limit air projections toward the aircraft fuselage, and/or in order to avoid air reinjection phenomena within the turbomachine or the adjacent turbomachine.

Firstly, with reference to FIGS. 18 to 20, a membrane 232 is shown which, in the deployed configuration, has a generally radially outwardly curved shape, here flattened arch-shaped extending lengthwise in the axial direction.

More specifically, the deployable deflecting membrane 232 has a front portion 202 forming a forward flap reaching to the base of the membrane, a rear portion 204 also forming a rearward flap reaching to the base of the membrane, and an intermediate portion 206 which connects the front and rear portions 202, 204 of the membrane. These three portions preferably have the same, relatively small, curvature, and they are inscribed aligned with each other. Forward flap means that the membrane extends downward in the forward direction, whereas rearward flap means that the membrane extends downward in the rearward direction.

From a radial amplitude point of view, unlike the first and second types of membrane 32, 132, the deployed membrane 232 extends radially outward without going beyond the movable reverser cowl in the retreated thrust reversal position. This conveys the flattened appearance of the membrane 232, which therefore does not extend beyond the aerodynamic lines of the reverser, radially outward in the thrust reversal configuration.

The membrane 232 defines, at a base thereof, an air inlet opening 210 in the membrane. This opening 210 is delimited by an opening contour 212, here interrupted, and which cooperates with a closed frame-shaped membrane support structure 266, here of rectangular shape. The membrane 232 is thus attached to the frame 266, which runs along the air inlet opening contour 212. Here also, this attachment may be carried out by a lap 214, or any other technique deemed appropriate.

The opening contour 212 comprises several portions, among which:
a front opening contour portion 212a, of rectilinear/straight shape parallel to the tangential direction, cooperating with a front portion of the same shape of the frame 266;
a rear opening contour portion 212b, of rectilinear/straight shape parallel to the tangential direction, cooperating with a rear portion of the same shape of the frame 266.

The opening contour 212 is thus interrupted at the opposite lateral ends 222 of the membrane 232, because the front end of the membrane 232 is secured to a front reinforcement 224a of the frame 266, and the rear end of the membrane 232 is secured to a rear reinforcement 224b of this frame 266.

In this respect, it is noted that the front and rear ends of the membrane 232 may be offset from each other along the axis A1. However, the membrane may not only extend from front to rear while being parallel or substantially parallel to the axis A1, but also extend while having a circumferential component, and therefore not being parallel to the axis A1. In the latter case, the front and rear ends of the membrane are thus offset from each other along the inclined axis of the membrane, having the circumferential component mentioned above.

On the other hand, at two straight lateral reinforcements 224c of the frame 266, of axial orientation, the opening contour 212 is interrupted along the entire axial length of the membrane, because the opposite lateral ends 222 thereof are located at a radial distance from these reinforcements 224c.

The front and rear ends of the membrane 232 are thus preferably rectilinear/straight, whereas the four reinforcements 224, 224b, 224c are preferably bar-shaped.

The opening contour 212 is preferably inscribed in an axial and tangential plane, and is located in the radial extraction opening mentioned above. Here also, it is noted that the axial length of the frame 266 is identical or substantially identical to the axial length of this radial air extraction opening 56. Moreover, it is also noted that the membrane 232 has the same type of cooperation with a sealing membrane 58 in the secondary flow, as that described above for the membrane 32. Similarly, its support structure 266 cooperates with the same type of front and rear interface parts 67, 69, the latter also being attached to the front and rear membrane support frames 70, 60.

In the embodiment shown in FIGS. 18 to 20, the membrane 232 has two air outlet openings 220. Each of these is delimited between one of the axially oriented and bar-shaped lateral reinforcements 224c, and one of the corresponding lateral ends 222 of the membrane. Each of the two air outlet openings 220, opposite in the circumferential direction, is thus inscribed generally in an axial and radial plane.

By producing the two outlet openings 220 in this way, each of the two resulting air outlet flows 220B″ may readily have a very high tangential component, or even a zero axial component to orient the outlet air tangentially, with optionally a low radial component. By deflecting the outlet air 90° in the tangential direction, it is primarily the lateral deflection function which is targeted, without for all that seeking an axial component likely to contribute to the counter-thrust function.

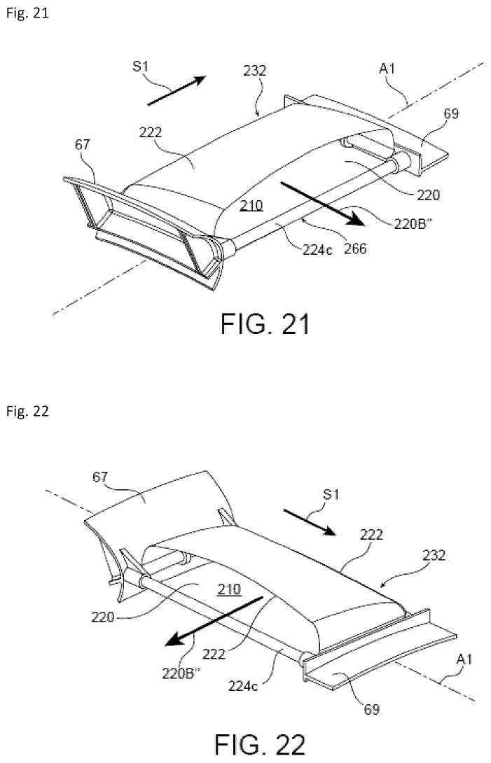

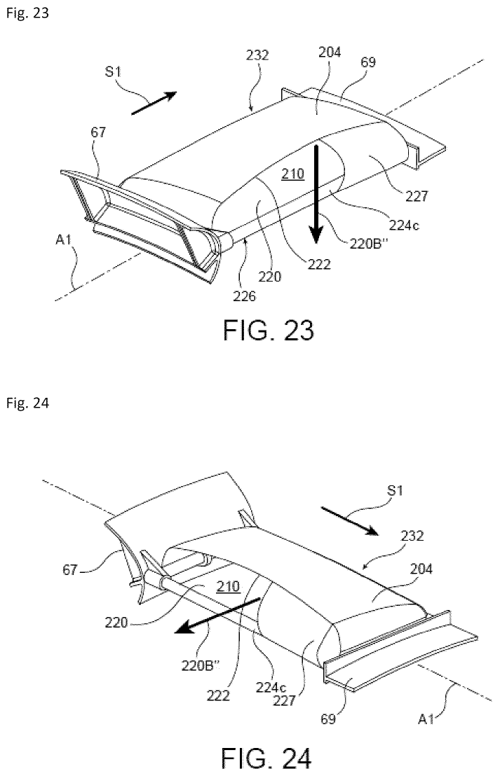

FIGS. 21 and 22 show an alternative, wherein only one lateral air outlet opening 220 is provided, between one of the lateral reinforcements 224c and one of the lateral ends 222 of the membrane. This membrane then has a second curvature from this lateral end 222, to the other lateral end 222 secured to the other lateral reinforcement 224c of the frame 266. This securing may be performed as for securing the front and rear ends of the membrane on their respective reinforcements 224, 224b, continuously along the latter. Regardless of the embodiment considered for the membrane 232 of the third type, FIGS. 23 and 24 show the option of adding, at the lateral air outlet opening 220, a rear lateral edge of the membrane 227.

This circumferentially rearward curved lateral edge 227 is secured to each of the following elements:
one of the two opposite lateral ends 222 of the membrane;
the rear end of the membrane corresponding to the end portion of its rear portion 204;
the rear end of the corresponding lateral reinforcement 224c.

Adding this lateral edge makes it possible to limit the axial extent of the air outlet opening 220 rearward, with the aim either of seeking a non-zero axial component for the outlet air flow 220B″, or, when a tangential flow with a zero axial component is sought, preventing this flow from being deflected rearward when it exits the opening 220. The lateral deflection angle of the air outlet flow 220B″, relative to the axial direction, may for example be in the order of 30°, 45° or 60°, according to the axial extent of the edge 227.

It should be noted that such a membrane 232 with one or two lateral edges is easy to obtain, for example by merely cutting a textile, respectively in an L or T shape. Finally, it is stated that regardless of the membrane type considered among those disclosed above, these membranes may be mechanically reinforced with straps or cables. Various modifications may be made by a person skilled in the art to the invention just described, only by way of non-limiting examples, and the scope of which is defined by the appended claims. For example, the thrust reverser 30 can alternatively have a “C-Duct” or “O-Duct” architecture. Furthermore, the membranes specific to the invention may coexist with conventional cascades within the reverser. Furthermore, all the features disclosed above, in the different preferred embodiments and their alternatives, can be combined with each other. Moreover, it is noted that in all the figures described above, elements bearing the same reference numbers correspond to identical or similar elements. Finally, it should be noted that sealing of the secondary flow path is preferably carried out by a flexible structure, such as membrane/textile, and/or by a rigid structure, such as conventional flap(s) according to the prior art.

1. A thrust reverser for an aircraft propulsion assembly, the reverser comprising a fixed structure equipped with a radially inner wall for delimiting a secondary flow path of the propulsion assembly intended to be crossed by a secondary flow, the reverser also comprising a movable structure comprising at least one movable reverser cowl equipped with a radially inner wall of a reverser cowl delimiting the secondary flow path radially outward, the movable structure being translatable relative to the fixed structure along a longitudinal central axis of the reverser, between an extended direct thrust position, and a retreated thrust reversal position wherein the movable structure and the fixed structure axially define between them, on the secondary flow path, a radial extraction opening of at least a portion of the secondary flow, the thrust reverser also comprising at least one deployable deflecting or obstructing membrane designed to deflect or obstruct at least a portion of the secondary flow escaping from the radial extraction opening when this deflecting or obstructing membrane is in a deployed configuration adopted when the movable structure is in the retreated thrust reversal position,
wherein in said deployed configuration, the membrane has a generally radially outwardly curved shape, and, defining at a base of the membrane, an air inlet opening in the membrane,
said deployable deflecting or obstructing membrane extending between:
a membrane front portion forming a forward flap reaching to the base of the membrane; and
a membrane rear portion forming a rearward flap reaching to the base of the membrane.

2. The thrust reverser according to claim 1, wherein the air inlet opening is delimited by an opening contour comprising:
a front opening contour portion of rounded shape;
a rear opening contour portion of rounded shape; and
at least one lateral opening contour portion arranged axially between the front and rear opening contour portions.

3. The thrust reverser according to claim 2, wherein said front portion of the membrane and said rear portion each have a generally quarter-sphere shape, an intermediate portion of the membrane, of generally half-cylinder shape, connecting the front and rear portions of the membrane.

4. The thrust reverser according to claim 1, wherein, in its deployed configuration, the membrane extends radially outward beyond the movable reverser cowl in the retreated thrust reversal position.

5. The thrust reverser according to claim 1, wherein the thrust reverser comprises a closed frame-shaped membrane support structure to which the base of the membrane is attached, the frame running along the air inlet opening contour.

6. The thrust reverser according to claim 1, wherein the membrane has at least one air outlet opening.

7. The thrust reverser according to claim 6, wherein the membrane has at least one air outlet opening produced at least partially through one of the two opposite circumferential faces of the membrane, as well as at least one air outlet opening produced at least partially through the other of the two opposite circumferential faces of the membrane.

8. The thrust reverser according to claim 6, wherein the membrane has several air outlet openings each produced at least partially through one of two opposite circumferential faces of the membrane, and following each other axially, the air outlet openings.

9. The thrust reverser according to claim 1, wherein the thrust reverser comprises at least two deployable deflecting or obstructing membranes, spaced apart from each other in the circumferential direction, of the same generally radially outwardly curved shape and of the same size, the two membranes being such that one comprises at least one air outlet opening and the other is devoid therefrom, or that one comprises at least one air outlet opening according to a first configuration, and the other comprises at least one air outlet opening according to a second configuration distinct from the first.

10. A nacelle for an aircraft propulsion assembly, comprising at least one fan cowl, as well as a thrust reverser according to claim 1.
